(19) United States
(12) Patent Application Publication
(10) Pub. No.: US 2009/0015173 A1
(43) Pub. Date: Jan. 15, 2009

(54) Electronic ballasts without toroidal-magnetic-core and fluorescent lamps employ the same

(75) Inventor: Onn Fah FOO, Hong Kong (CN)

Correspondence Address: RABIN & Berdo, PC, 1101 14TH STREET, NW, SUITE 500, WASHINGTON, DC, 20005, US

(73) Assignee: MASS TECHNOLOGY (H.K.) LTD., Kowloon (HK)

(21) Appl. No.: 12/143,004

(22) Filed: Jun. 20, 2008

(30) Foreign Application Priority Data
Jul. 13, 2007 (CN) 200710130302.0

(51) Int. Cl. H05B 41/24; H02M 7/217

(52) U.S. Cl. 315/247; 363/127

(57) ABSTRACT

A toroid-free ballast comprising a filter and rectifier circuit (10) coupled with an AC power, a switch and resonant circuit (20) coupled with the filter and rectifier circuit (10), characterized in that, the switch and rectifier circuit (20) comprises a half bridge oscillating circuit composed of two transistors. The present invention has the benefits of being toroid-free, as well as being relatively compact in configuration, low in cost and favourable for the miniaturization of the electronic ballast.

### TECHNICAL FIELD

The present invention relates to a ballast circuitry, and more particularly to a toroid-free ballast and a fluorescent lamp employs the same.

### BACKGROUND OF THE INVENTION

In order to minimize adverse effects of a toroid to an electronic ballast, the Chinese Utility Model Patent No. 99211363.6 disclosed an energy saving lamp having a toroid-free ballast (refer to FIG. 1), wherein the half bridge power amplifier 30 is realized with FETs M1, M2, but the manufacturing process for FET is relatively complex and the selectivity thereof is relatively poor. Further, the driving current limiter 40 is realized with a load transformer, and thus, the driving current limiter has to be connected with inductors L1, L2 and capacitors C1, C2, which results in a complicated circuitry and increased cost and brings adverse effect to the miniaturization of the electronic ballast.

### SUMMARY OF THE INVENTION

An object of the present invention is to overcome the above defects by providing an improved toroid-free ballast having the benefits of being toroid-free, as well as being relatively compact in configuration, low in cost and favourable for the miniaturization of the electronic ballast.

Accordingly, the technical solution of the present invention provided for the above object being a toroid-free ballast, which comprises a filter and rectifier circuit coupled with an AC power supply, a switch and resonant circuit coupled with the filter and rectifier circuit, characterized in that the switch and rectifier circuit comprises a half bridge oscillating circuit formed of two transistors.

According to an embodiment of the present invention, the switch and resonant circuit comprises a first and a second transistors; wherein emitter of the first transistor is coupled with collector of the second transistor via a fifth resistor at a junction point; a second capacitor is connected across collector of the first transistor and the junction point; a first resistor is connected across the collector and base of the first transistor; a seventh resistor is coupled to the base of the first transistor with its one end and coupled to cathode of a fifth diode with its another end, while anode of the fifth diode is coupled with the junction point; and a third resistor, a seventh capacitor, a first inductor and a first secondary winding of a transformer are serially connected across the base of the first transistor and the junction point, wherein the junction point is connected with cathode of the first secondary winding; a second resistor is connected across the collector and base of the second transistor; a eighth resistor is coupled to the base of the second transistor with its one end and coupled to cathode of a sixth diode with its another end, while anode of the sixth diode is coupled with emitter of the second transistor via a sixth resistor; and a fourth resistor, a eighth capacitor, a second inductor and a second secondary winding of the transformer are serially connected across the base of the second transistor and the anode of the sixth diode, wherein the anode of the sixth diode is connected with anode of the second secondary winding; and positive terminal of a primary winding of the transformer is coupled with the junction point.

According to another embodiment of the present invention, the switch and resonant circuit further comprises a resonant capacitor connected across the negative terminal of the primary winding and the positive terminal of the second secondary winding.

According to a further embodiment of the present invention, it further comprises a power factor correction circuit coupled between the filter and rectifier circuit and the switch and resonant circuit. Preferably, the power factor correction circuit comprises a MOS switching transistor, a booster inductor, a booster diode, an output capacitor and a power factor correction controller; wherein anode and cathode of the booster diode are respectively coupled with the booster inductor and anode of the output capacitor, while the MOS switching transistor is coupled with the power factor correction controller, the anode of the booster diode and cathode of the output capacitor at its gate, source and drain, respectively.

According to still another embodiment of the present invention, the filter and rectifier circuit is a full bridge rectifier circuit comprising a filter composed of an inductor and a resistor in shunt connection, a bridge rectifier and an electrolyte capacitor connected across first and third terminals of the bridge rectifier; the filter is coupled with the AC power supply at one end via a fuse while coupling with second terminal of the bridge rectifier at another end.

According to yet still another embodiment of the present invention, a ratio of winding between the primary winding and the secondary windings of the transformer ranges from 30:1 to 400:1.

According to a further embodiment of the present invention, the fifth and sixth resistors are equal in resistance.

According to the present invention, it further provides a fluorescent lamp having a toroid-free ballast according to anyone of foregoing embodiments, wherein it further comprises a lamp load coupled with the switch and resonant circuit.

According to an embodiment of the present invention, the lamp load comprises a lamp tube, a fourth capacitor and a fifth capacitor; wherein two connection points are respectively arranged at each ends of the lamp tube, wherein the fourth capacitor is connected at one of the connection points, while the fifth capacitor is connected across two corresponding connection points at opposite ends of the lamp tube; characterized in that the lamp load further comprises a preheating device in shunt connection with the fifth capacitor.

According to another embodiment of the present invention, the preheating device is a positive temperature coefficient thermistor.

With respect to the prior art, the present invention adopts transistors rather than field effect transistors, whereby it possess the advantages of being toroid-free as well as being relatively compact in configuration, low in cost and favourable for the miniaturization of the electronic ballast.

### BRIEF DESCRIPTION OF THE DRAWINGS

FIG. 1 is a circuit diagram of a ballast of the prior art;

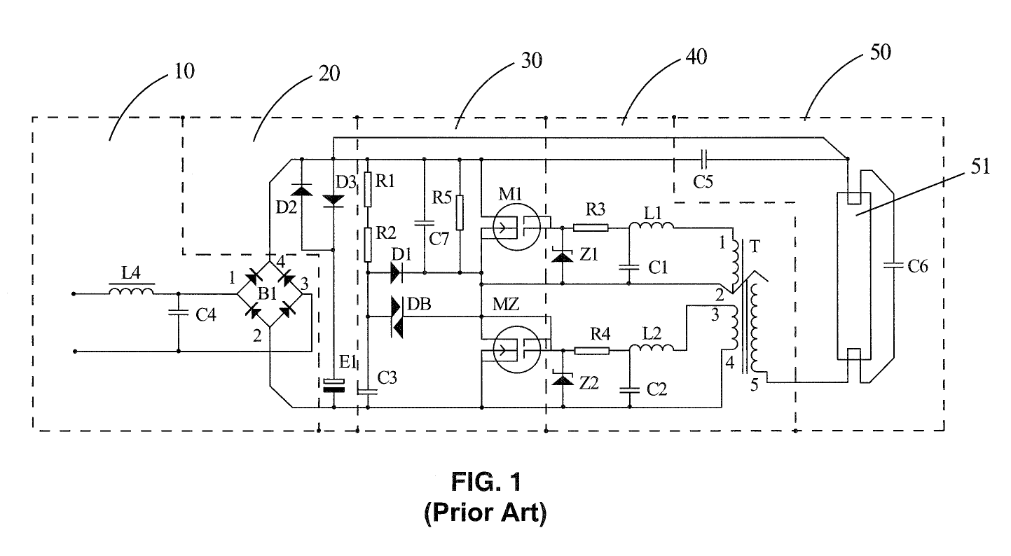

FIG. 2 is a circuit configuration diagram of a toroid-free ballast according to an embodiment of the present invention;

FIG. 3 is a circuit configuration diagram of a toroid-free ballast according to another embodiment of the present invention;

FIG. 4 is a circuit configuration diagram of a toroid-free ballast according to still another embodiment of the present invention;

### DETAILED DESCRIPTION OF THE PREFERRED EMBODIMENTS

The toroid-free ballast of the present invention will be described in further details with reference to the accompany drawings.

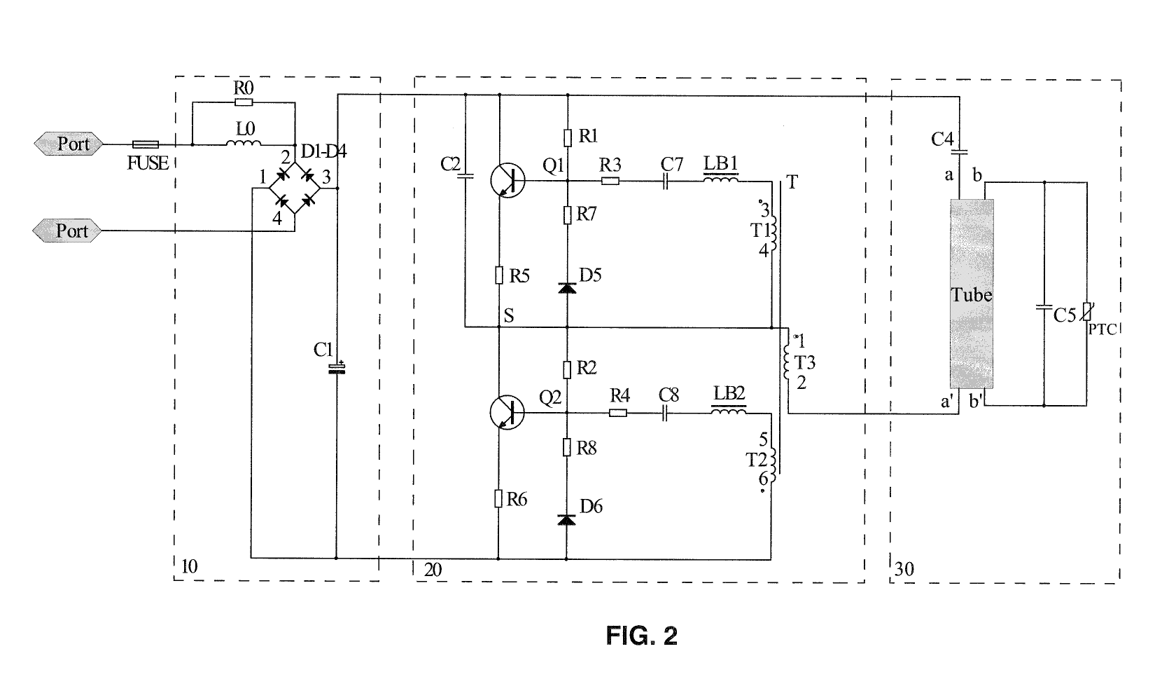

Please refer to FIG. 2, which illustrates a toroid-free ballast according to an embodiment of the present invention comprising a filter and rectifier circuit 10 and a switch and resonant circuit 20, as well as an exemplary lamp load 30.

The filter and rectifier circuit 10 is coupled to input ends of the switch and resonant circuit 20 with its output ends, and being further coupled to an AC power supply to convert input ac voltage to dc voltage after filtering out the electromagnetic interference thereof. In the embodiment, the filter and rectifier circuit 10 is a full bridge rectifier circuit comprising a bridge rectifier (D1˜D4), a filter comprised of an inductor L0 and a resistor R0 in shunt connection and an electrolyte capacitor C1 shuntly connected across terminals 1 and 3 of the bridge rectifier; the filter is coupled with the AC power supply at one end via a fuse FU while coupling with terminal 2 of the bridge rectifier at another end.

The switch and resonant circuit 20 is coupled to the lamp load 30 with its output ends and including: two transistors Q1, Q2, wherein emitter of the transistor Q1 is connected with collector of Q2 via a resistor R5, a junction point S is located between the resistor R5 and the collector of the transistor Q2, and a capacitor C2 is connected across collector of the transistor Q1 and the junction point S; a resistor R1 is coupled to terminal 3 of the filter and rectifier circuit 10 with its one end and coupled to base of the transistor Q1 with its another end; a resistor R7 is coupled to the base of the transistor Q1 with its one end and coupled to the junction point S with its another end via a diode D5 in series connection; a resistor R3 is coupled to the base of the transistor Q1 with its one end, while its another end is serially connected with a capacitor C7 and a inductor LB1 for coupling with terminal 3 of a secondary winding T1 of a transformer T; and emitter of the transistor Q2 is connected with terminal 6 of a secondary winding T2 of the transformer T via a resistor R6, while base of the transistor Q2 is connected with the junction point S via a resistor R2; a resistor R8 is coupled to the base of the transistor Q2 with its one end, while its another end is serially connected with a diode D6 for coupling with terminal 6 of the secondary winding T2 of the transformer T; a resistor R4 is coupled to the base of the transistor Q2 with its one end, while its another end is serially connected with a capacitor C8 and a inductor LB2 for coupling with terminal 5 of the secondary winding T2 of the transformer T; a primary winding T3 of the transformer is coupled with a lamp tube of the lamp load 30 with its terminal 2, while its terminal 1 and terminal 4 of the secondary winding T1 are connected at the junction point S; the secondary windings T1, T2 provide drive current for the transistors Q1, Q2 of the circuit, and the terminal 2 of the primary winding T3 is connected with the lamp tube and a capacitor C5 whereby enabling the primary winding T3 and the capacitor C5 form a resonant circuit.

The lamp load 30 comprises the lamp tube and the capacitors C4, C5 wherein the capacitor C4 is used for dc blocking; and at both ends of the lamp tube two connection points a, b, a′, b′ are respectively provided, the capacitor C5 in shunt connection with the lamp tube is connected across one connection point b, b′ at both ends of the lamp tube; another connection point a′ at one end of the lamp tube is coupled with the terminal 2 of the primary winding T3, while another connection point a at another end of the lamp tube is coupled with the collector of the transistor Q1 via the capacitor C4. According to one preferred embodiment, the capacitor C5 is further in shunt connection with a preheating device, and preferably a PTC preheating device, such as a PTC thermistor.

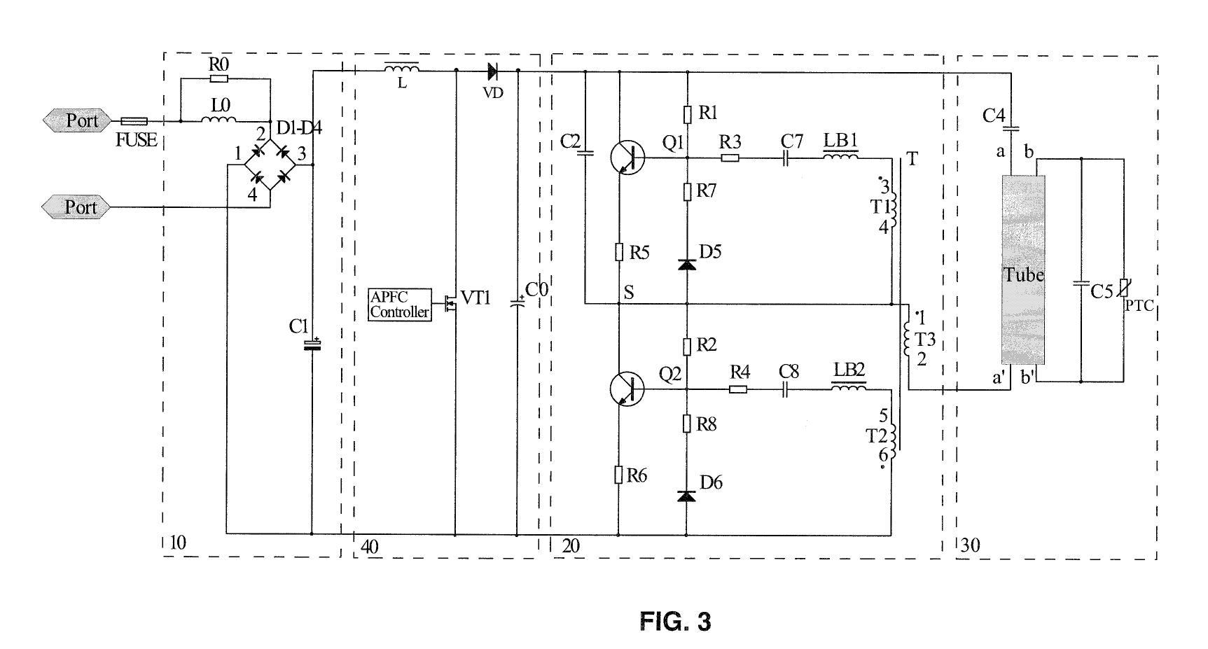

Please refer to FIG. 3, a toroid-free ballast according to another embodiment of the present invention is illustrated, which further comprises an optional power factor correction circuit 40 with respect to the one in FIG. 2. It should be noted that the necessity of the arrangement of the optional power factor correction circuit 40 depends on the power to be attained by the toroid-free ballast. The circuit 40 is coupled to the output end of the filter and rectifier circuit 10 with its input end and coupled to the input end of the switch and resonant circuit 20 with its output end. The power factor correction circuit 40 comprises a MOS switching transistor VT1, a booster inductor L, a booster diode VD, an output capacitor C0 and a power factor correction controller (APFC controller) integrated circuit for connecting power factor and adjusting its input DC voltage so that the output DC voltage will not be affected_by the change of load to maintain the stable power factor; wherein the booster inductor L is coupled to terminal 3 of bridge rectifier with one end and coupled to the collector of the transistor Q1 with another end through the booster diode VD; the booster diode VD is coupled with terminal 1 of the bridge rectifier at its cathode via the output capacitor C0 and coupled with the terminal 1 of the bridge rectifier via the MOS switching transistor VT1, while the gate of the MOS switching transistor VT1 is coupled to the power factor correction controller APFC controller.

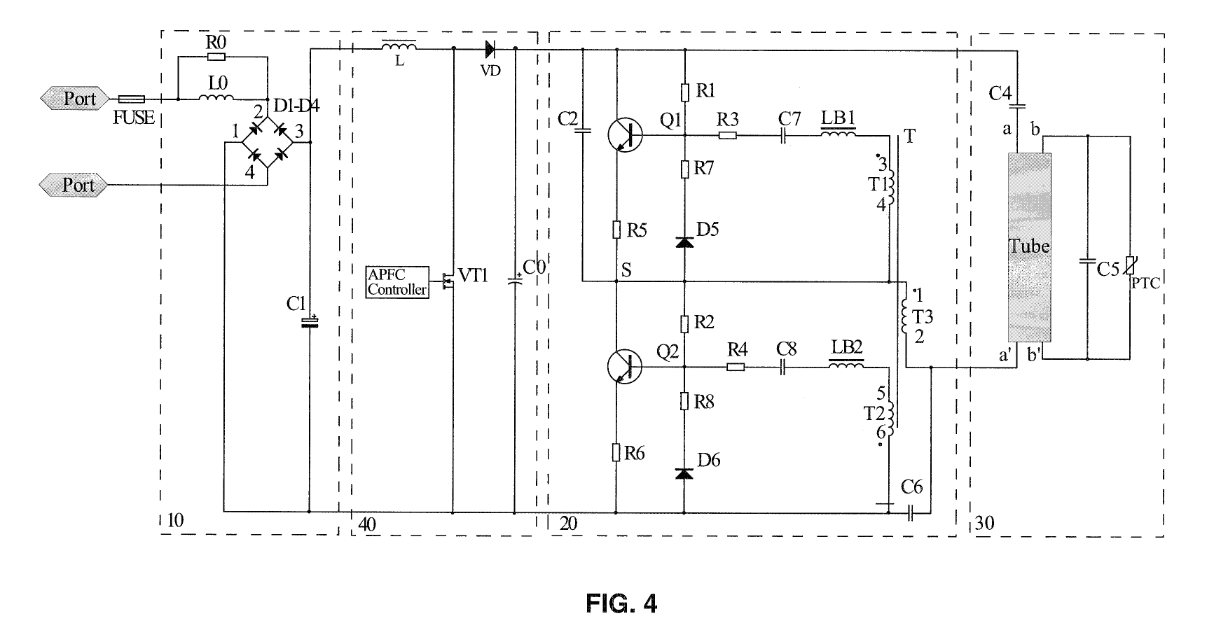

Please refer to FIG. 4, a toroid-free ballast according to a further embodiment of the present invention is illustrated, wherein the switch and resonant circuit 20 further comprises a resonant capacitor C6 with respect to the embodiment shown in FIG. 3.

The working principle of the present invention is as follows: the inductor L0 and resistor R0 of the filter and rectifier circuit 10 of the present invention are being employed for eliminating the clutter interference in the power source and preventing the clutter signals from entering into the ballast or preventing the high frequency signals in the ballast from entering into the power source; the rectifying diodes D1-D4 convert input ac current to dc current such that a stable dc current is obtained at positive terminal of the electrolyte capacitor C1. The MOS switching transistor VT1, booster inductor L, booster diode VD, output capacitor C0 and the power factor correction controller (APFC controller) integrated circuit form a feedback type power factor correction circuit which enables a power factor larger than 0.9. Transistors Q1, Q2 form a half bridge resonant circuit; when Q2 conducts, a current flows through the capacitor C4, two sets of filaments of the lamp tube, capacitor C5, primary winding T3 of the transformer T and the transistor Q2 to form a closed circuit, whereby generating an induced electrodynamic potential on the primary winding T3 of the transformer and also an induced electrodynamic potential on the secondary windings T1, T2 of the transformer, wherein the ends denoted with represent a positive polarity; the voltage polarity of energy storage inductors, namely the secondary windings T1, T2, will be varied due to the variations of the current during the charging process, in this way, transistors Q1, Q2 conduct and cut off in an alternate manner thereby forming a high frequency signal for excitation of the lamp tube. In the circuitry, the capacitor C7, inductor LB1, capacitor C8 and inductor LB2 form a oscillation circuit in the secondary loop, wherein the oscillation frequency can be altered by changing the values of the inductance and capacitance. While the parameters of the main resonant circuit formed with the primary winding T3 of the transformer T and capacitor C5 can be matched with one another, the entire circuitry will be operated in a stable condition. The resonant capacitor C6 in the circuitry will facilitate the optimum ignition of the lamp tube.

It should be appreciated that the above are merely provided for illustrating but not limiting the present invention. While the present invention has been described in details with references to above embodiments, it will be understood by those skilled in the art that various amendments may be made and equivalents may be substituted for elements thereof as required, and those alterations and/or modifications without departing from the spirit and scope of the present invention shall all fall into the scope of the following claims.

What is claimed is:

1. A toroid-free ballast comprising a filter and rectifier circuit (10) coupled with an AC power supply, a switch and resonant circuit (20) coupled with the filter and rectifier circuit (10), characterized in that, the switch and rectifier circuit (20) comprises a half oscillating bridge circuit composed of two transistors.

2. A toroid-free ballast according to claim 1, wherein the switch and resonant circuit (20) comprises a first and a second transistors (Q1, Q2); wherein emitter of the first transistor (Q1) is coupled with collector of the second transistor (Q2) via a fifth resistor (R5) at a junction point (S); a second capacitor (C2) is connected across collector of the first transistor (Q1) and the junction point (S); a first resistor (R1) is connected across the collector and base of the first transistor (Q1); a seventh resistor (R7) is coupled to the base of the first transistor (Q1) with its one end and coupled to cathode of a fifth diode (D5) with its another end, while anode of the fifth diode (D5) is coupled with the junction point (S); and a third resistor (R3), a seventh capacitor (C7), a first inductor (LB1) and a first secondary winding (T1) of a transformer (T) are serially connected across the base of the first transistor (Q1) and the junction point (S), wherein the junction point (S) is connected with cathode of the first secondary winding (T1); a second resistor (R2) is connected across the collector and base of the second transistor (Q2); a eighth resistor (R8) is coupled to the base of the second transistor (Q2) with its one end and coupled to cathode of a sixth diode (D6) with its another end, while anode of the sixth diode (D6) is coupled with emitter of the second transistor (Q2) via a sixth resistor (R6); and a fourth resistor (R4), a eighth capacitor (C8), a second inductor (LB2) and a second secondary winding (T2) of the transformer (T) are serially connected across the base of the second transistor (Q2) and the anode of the sixth diode (D6), wherein the anode of the sixth diode (D6) is connected with anode of the second secondary winding (T2); and positive terminal of a primary winding (T3) of the transformer (T) is coupled with the junction point (S).

3. A toroid-free ballast according to claim 2, wherein the switch and resonant circuit (20) further comprises a resonant capacitor (C6) connected across the negative terminal of the primary winding (T3) and the positive terminal of the second secondary winding (T2).

4. A toroid-free ballast according to claim 1, wherein it further comprises a power factor correction circuit (40) coupled between the filter and rectifier circuit (10) and the switch and resonant circuit (20).

5. A toroid-free ballast according to claim 4, wherein the power factor correction circuit (40) comprises a MOS switching transistor (VT1), a booster inductor (L), a booster diode (VD), an output capacitor (C0) and a power factor correction controller (APFC controller); wherein anode and cathode of the booster diode (VD) are respectively coupled with the booster inductor (L) and anode of the output capacitor (C0), while the MOS switching transistor (VT1) is coupled with the power factor correction controller (APFC controller), the anode of the booster diode (VD) and cathode of the output capacitor (C0) at its gate, source and drain, respectively.

6. A toroid-free ballast according to claim 1, wherein the filter and rectifier circuit (10) is a full bridge rectifier circuit comprising a filter composed of an inductor (L0) and a resistor (R0) in shunt connection, a bridge rectifier (D1-D4) and an electrolyte capacitor (C1) connected across first and third terminals of the bridge rectifier (D1-D4); the filter is coupled with the AC power supply at one end via a fuse while coupling with second terminal of the bridge rectifier (D1-D4) at another end.

7. A toroid-free ballast according to claim 2, wherein a ratio of winding between the primary winding (T3) and the secondary windings (T1, T2) of the transformer (T) ranges from 30:1 to 400:1.

8. A fluorescent lamp having a toroid-free ballast according to claims 1, wherein it further comprises a lamp load (30) coupled with the switch and resonant circuit (20).

9. A fluorescent lamp according to claim 8, wherein the lamp load (30) comprises a lamp tube, a fourth capacitor (C4) and a fifth capacitor (C5); at both ends of the lamp tube two connection points (a, b, a′, b′) are respectively arranged, wherein the fourth capacitor (C4) is connected at one of the connection points (a), while the fifth capacitor (C5) is connected across two corresponding connection points (b, b′) at opposite ends of the lamp tube; characterized in that the lamp load (30) further comprises a preheating device (PTC) in shunt connection with the fifth capacitor (C5).

10. A fluorescent lamp according to claim 9, wherein the preheating device (PTC) is a positive temperature coefficient thermistor.
